(19) United States
(12) Patent Application Publication
(10) Pub. No.: US 2006/0072483 A1
(43) Pub. Date: Apr. 6, 2006

(54) Method for enhancing telephone service

(75) Inventor: Samuel H. Schwartz, Penn Valley, PA (US)

Correspondence Address: BROOKS KUSHMAN P.C., 1000 TOWN CENTER, TWENTY-SECOND FLOOR, SOUTHFIELD, MI, 48075, US

(73) Assignee: Comcast Interactive Capital, LP, Wilmington, DE (US)

(21) Appl. No.: 10/957,280

(22) Filed: Oct. 1, 2004

(51) Int. Cl. H04L 12/16

(52) U.S. Cl. 370/259

(57) ABSTRACT

A method for enhancing telephone service to provide enhanced-features through a user-friendly interface is provided. An enhanced-feature server is connected to the telephone service and provides an enhanced-feature service. A user-friendly enhanced-feature device uses the enhanced-feature service. The enhanced-feature server communicates with the telephone service and relays/formats appropriate information among the telephone and the enhanced-feature device.

### BACKGROUND OF THE INVENTION

1. Field of the Invention

The invention relates to voice over Internet protocol (VoIP) service, and to providing enhanced features at the telephone unit.

2. Background Art

The use of the Internet and more specifically the use of Internet protocol (IP) to provide services is growing. One IP service that has been growing in popularity is voice over IP (VoIP) service. In a certain existing VoIP implementation, an IP network sits between the telephone network and the traditional in-building analog telephone wiring. The IP network connects to the telephone network through a VoIP gateway; an in-building adapter, modem or gateway interfaces the in-building analog telephone wiring to the IP network. In this way, an IP telephony connection connects the in-building telephone wiring to other buildings, users or services on the telephone or IP networks.

Generally, a traditional analog telephone connected to the in-building analog telephone wiring is operated in the same way regardless of whether the ultimate connection to the telephone network is through a traditional analog circuit or a digital VoIP connection. Further, the traditional telephone ‘CLASS’ features are still available when VoIP is utilized as the transport. But in this same way, existing VoIP implementations that make the IP connection transparent to the end-user are providing an alternative connection to the telephone network but are failing to utilize the full potential available with an IP connection.

There is a need for an improved VoIP arrangement that enhances VoIP service to provide enhanced features to the user at the analog telephone unit.

### SUMMARY OF THE INVENTION

It is an object of the invention to provide a method for enhancing VoIP service to provide enhanced features through user-friendly equipment. The invention is about using an end-to-end IP datapath to reach the user's endpoint to enhance the user's experience while using a combined IP and analog datapath for the VoIP service. Further, in a more general sense, the invention is about bringing the benefits of an IP datapath to a telephone. The telephone could be utilizing VoIP but this is not critical in the broader aspects of the invention. The important point is that the benefits of an IP datapath are brought to a telephone where the ordinary last communication leg to the telephone is limited, for example, an analog telephone (that may or may not use VoIP, a wireless telephone, or any other device having a limited communication path so as to benefit from the IP datapath).

In one contemplated approach, the invention involves a VoIP service. The VoIP service is provided over a distribution network including a VoIP gateway that connects to the traditional circuit-switched telephone network. On the user end, the distribution network includes a suitable interface to connect to an analog telephone on the in-building (or other user-side) network. In this way, the telephone on the user end connects to services or other users on the IP network or through the VoIP gateway and utilizes the provided VoIP service when making telephone calls. The telephone network services ride on top of the IP connection provided by the VoIP service and are normally controlled and directed by a VoIP softswitch (of any suitable implementation).

In an aspect of the invention, the invention further comprehends an enhanced-feature service. The enhanced-feature service is provided over a distribution network including an enhanced-feature server. On the user end, this distribution network connects to a user-friendly enhanced-feature device. The enhanced-feature device is connected through an IP connection to the enhanced-feature server. In this way, the enhanced-feature device on the user end connects to the enhanced-feature server and utilizes the enhanced-feature service. The enhanced-feature device may or may not be integrated with the analog telephone. The enhanced-feature server may or may not be integrated with the VoIP softswitch.

The invention involves the interaction of the enhanced-feature service and the VoIP service. That is, the invention is more about services than about any particular hardware or software implementation. The invention provides enhanced features using the user-friendly enhanced-feature device through the interaction of the enhanced-feature service and the VoIP service.

The services themselves may be implemented in a variety of ways within the overall scope of the invention. The distribution network may take various forms, and it is even possible for the VoIP service and the enhanced-feature service to be served using different distribution techniques depending on the application. Further in this aspect, the VoIP softswitch and the enhanced-feature server may take various forms and it is possible that services are provided from the same server or different servers.

In carrying out a method according to the invention, the VoIP service connects the telephone on the user end to the VoIP gateway. The VoIP service could also connect the user to another user on the VoIP service without having to go through a gateway to the traditional circuit switched network. Telephone services from the telephone network ride on top of the IP connection provided by the VoIP service. Some telephone services may reside inside the VoIP network. The enhanced-feature service connects the enhanced-feature device to the enhanced-feature server, which is connected directly (or indirectly by a VoIP softswitch or other systems) to the VoIP gateway, calling feature servers, announcement servers, databases and/or other telephony network equipment, servers and services.

The user's enhanced-feature device provides an interface (preferably including a display screen) for intuitively accessing and controlling telephony calling features, information applications (for example, white pages, local advertising, personalized content, messaging), cross-promotion and e-commerce. The enhanced-feature server communicates with the softswitch, Internet and other network elements to gather information for the user's benefit or to implement user requests. The enhanced-feature server prepares, receives, relays and/or reformats the appropriate information or user instructions among the enhanced-feature device, the VoIP softswitch, the traditional circuit-switched telephone network and any other relevant network elements or servers. In this way, the enhanced-feature service (working together with the VoIP service) better utilizes the available potential of the IP connection by enhancing the capabilities of the end user. It is the presence of the enhanced-feature service and associated enhanced-feature device that provides these enhanced capabilities to the end-user as compared to an end-user who accesses the VoIP service and its features through only an analog telephone. For example, using the enhanced feature device to look up a white pages listing and then dial that party directly through one key press on the enhanced-feature device.

It is appreciated that although the concepts involved in the invention are conveyed while mentioning Internet protocol (IP), IP is just one example of a suitable network protocol for data service to allow the innovative service combination to be implemented. More generally, the contemplated enhanced-feature service may be employed to enhance any phone service including VoIP or voice over any data service as well as to enhance a traditional circuit-switched phone service. To enhance a traditional circuit-switched phone service, the VoIP softswitch or traditional circuit switch allows communication between the enhanced-feature service and components of the traditional telephone service. Further, the contemplated enhanced-feature service may enhance phone services that do not or do not always rely on the traditional telephone network, for example, end-to-end VoIP calls or even calls made with IP phones. In that same way, the physical aspects of the network may vary as well. In one situation, IP over hybrid fiber coax (HFC) may be appropriate, while in other situations, for example, wireless links may be involved. Put another way, the service connections are logical connections and hardware and software architecture may vary.

### BRIEF DESCRIPTION OF THE DRAWINGS

FIG. 1 illustrates the network architecture in the preferred embodiment of the invention; and

FIG. 2 illustrates the method in the preferred embodiment of the invention.

### DETAILED DESCRIPTION OF THE PREFERRED EMBODIMENT

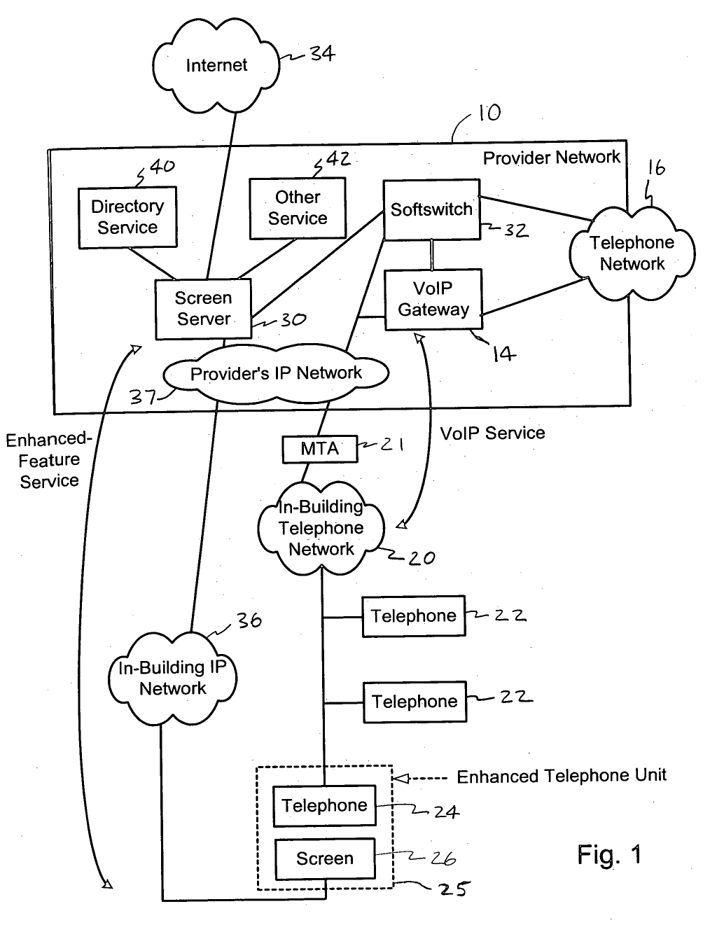

With reference to FIG. 1, the network architecture in the preferred embodiment of the invention includes a provider network 10. The network architecture is shown in a much simplified fashion. A voice over Internet protocol (VoIP) gateway 14 (if needed) is located at provider network 10 and connects to telephone network 16 (which can be circuit-switched network(s) and/or VoIP network(s)). On the user-end of the distribution network, the network connects through media terminal adapter (MTA) 21 to in-building telephone network 20. In this way, telephones 22 on the user end connect to VoIP gateway 14 and softswitch 32, and utilize a provided VoIP service when making telephone calls over telephone network 16. The telephone network services of telephone network 16 ride on top of an IP connection between gateway 14 and the user provided by the VoIP service.

Generally, any of traditional telephones 22 connected to in-building telephone network 20 are operated in the same way regardless of whether the connection to telephone network 16 is through a traditional land line or a VoIP service connection. Traditional telephone services are still available to telephones 22 when VoIP service is utilized.

Enhanced telephone unit 25 includes telephone 24 which is connected to in-building telephone network 20 and further includes an integral enhanced-feature device having an interface in the form of screen 26. Enhanced telephone unit 25 is a user-friendly piece of equipment intended to provide enhanced-features via screen interface 26 for enhancing VoIP service to telephone 24. In this way, enhanced telephone unit 25 provides enhanced services relative to traditional telephones 22 when used in the VoIP environment. Telephone 24 and the enhanced-feature device need not form an integral unit. More specifically, telephone 24 and screen 26 can be separate devices or physically separate devices.

With continuing reference to FIG. 1, an enhanced-feature server in the form of a screen server 30 is shown. Screen server 30 connects over the provider network to the enhanced telephone unit's integrated or separate enhanced-feature client device. More specifically, a connection over local IP network 36 and provider's IP network 37 to connect screen server 30 provides the enhanced-feature service.

The exemplary embodiment of the invention involves the interaction of the enhanced-feature service provided by screen server 30 and the VoIP service provided by VoIP softswitch 32. That is, the preferred embodiment of the invention is more about the interaction of services then about any particular hardware or software implementation. More specifically, enhanced-features are provided to enhanced telephone unit 25 through the interaction of the enhanced-feature service and the VoIP service. Again, an enhanced-feature device could also be implemented as a stand alone device.

In a preferred approach, an end-to-end IP datapath is used to reach the user's end point to enhance the user's experience while using a combined IP and analog datapath for the VoIP service. Other approaches are also possible, with the important aspect being the bringing of the benefits of an IP datapath to a telephone when the ordinary last communication leg to the telephone is limited.

With continuing reference to FIG. 1, the VoIP service and the enhanced-feature service are provided over the provider network and then over telephone network 20 and IP network 36, respectively. It is appreciated that the VoIP service and the enhanced-feature service may be distributed in other ways depending on the implementation. Further, implementation of the relevant servers, protocols, and network topologies may vary depending on the implementation. In one situation, IP over hybrid fiber coax (HFC) may be appropriate, while in other situations, for example, wireless links may be involved for one or both services. Put another way, the service connections are logical connections and the hardware and software architecture may vary.

In operation, the VoIP service connects telephone 24 on the user end to VoIP gateway 14 or to other telephones on the VoIP service. Telephone services from telephone network 16 ride on top of the IP connection provided by the VoIP service. Again, some services may originate inside the IP network, not just from the telephone network 16. The enhanced-feature service connects screen 26 to screen server 30. Screen server 30 is connected by softswitch 32 (of any suitable implementation) to VoIP gateway 14.

Enhanced telephone unit 25 provides screen interface 26 for intuitively accessing calling features, information applications (for example, white pages, local advertising, personalized content, messaging), cross-promotion and e-commerce. Many other enhancements are possible and enhancements may further relate to messaging, presence, voice, video, data, or other applications. Screen server 30 communicates with softswitch 32, Internet 34 and other network elements and relays/formats the appropriate information among the telephone 24, screen 26, and the network elements. In this way, the enhanced-feature service (working together with the VoIP service) better utilizes the available potential for the IP connection. It is also to be appreciated that other protocols for data service may be used in combination with or in alternative to Internet protocol.

The enhanced-feature service may be employed to enhance any phone service and is not limited to VoIP. For example, other voice over data services, traditional circuit-switched or wireless phone services, and hybrid arrangements could be enhanced by embodiments of the invention. In this way, any phone service may communicate with the enhanced-feature service.

In addition, the enhanced-feature device may coordinate access to other services that may be dependent on or independent from the involved phone service. In the examples illustrated, directory service 40 and other service 42 are connected to screen server 30. In this way, these other services are accessed with the assistance of the enhanced-feature device.

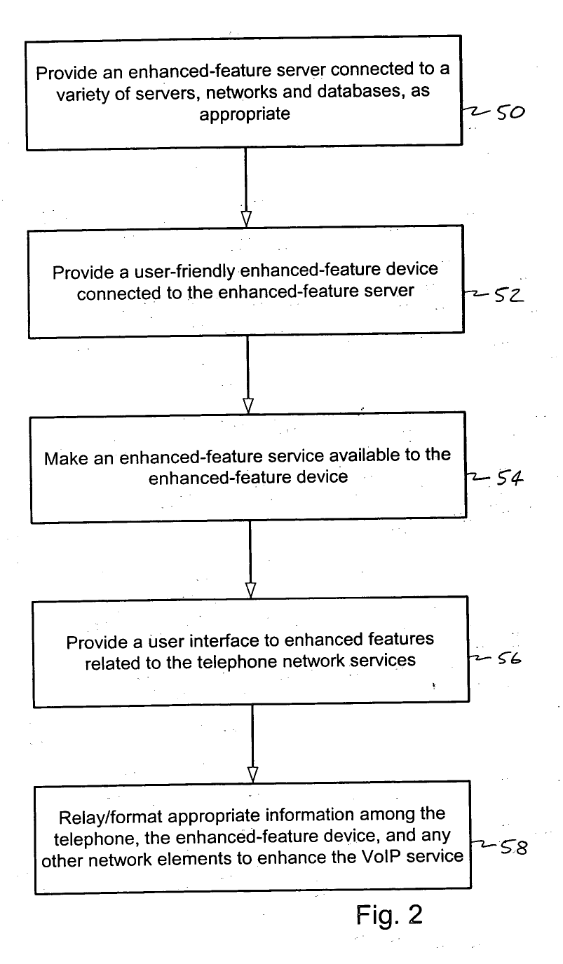

With reference to FIG. 2, a method in the preferred embodiment of the invention is illustrated. At block 50, an enhanced-feature server is provided. At block 52, a user-friendly enhanced-feature device connected to the enhanced-feature server is provided. The enhanced-feature service is made available to the enhanced-feature device at block 54.

With continuing reference to FIG. 2, at block 56, a user interface to enhanced features related to the telephone network services is provided. At block 58, the enhanced-feature server communicates with the softswitch, Internet and other network elements and services and relays/formats the appropriate information among the telephone, the various networks involved, the enhanced-feature device, and the network elements.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for enhancing a telephone service wherein the ordinary last communication leg to the telephone is limited to provide enhanced features through a user-friendly interface, the method comprising:
providing an enhanced-feature server connected to the telephone service, the enhanced-feature server providing an enhanced-feature service and being connected to a distribution network;
providing a user-friendly enhanced-feature device connected to the enhanced-feature server by the distribution network; and
making the enhanced-feature service available to the enhanced-feature device, wherein the enhanced-feature service provides a user interface to enhanced features related to the telephone service, and wherein the enhanced-feature server communicates with the telephone service and relays/formats appropriate information among the telephone and the enhanced-feature device, thereby enhancing the telephone service with enhanced features from the enhanced-feature service.

2. The method of claim 1 wherein the interface to enhanced features includes an interface for intuitively accessing calling features of the telephone service.

3. The method of claim 1 wherein the interface to enhanced features includes an interface for intuitively accessing information applications that enhance the telephone service.

4. The method of claim 1 wherein the telephone and the enhanced-feature device are integrated as a single device.

5. The method of claim 1 wherein the interface to the enhanced-feature device includes a display screen.

6. The method of claim 1 wherein the telephone service is in the form of a voice over data service providing a data connection extending between a telephone network and an interface connected to the telephone, wherein telephone network services ride on top of the data connection provided by the voice over data service.

7. A method for enhancing a voice over Internet protocol (VoIP) service to provide enhanced features through a user-friendly interface, the VoIP service providing an IP connection, the IP connection extending between a telephone network and an interface connected to a telephone on a user-side network, wherein telephone network services ride on top of the IP connection provided by the VoIP service, the method comprising:
providing an enhanced-feature server in communication with the telephone network, the enhanced-feature server providing an enhanced-feature service and being connected to a distribution network;
providing a user-friendly enhanced-feature device connected to the enhanced-feature server by the distribution network; and
making the enhanced-feature service available to the enhanced-feature device, wherein the enhanced-feature service provides a user interface to enhanced features related to the telephone network services, and wherein the enhanced-feature server communicates with the telephone network and relays/formats appropriate information among the telephone, the enhanced-feature device, and any other network elements thereby enhancing the VoIP service provided over the IP connection with enhanced features from the enhanced-feature service.

8. The method of claim 7 wherein the interface to enhanced features includes an interface for intuitively accessing calling features of the telephone network services.

9. The method of claim 7 wherein the interface to enhanced features includes an interface for intuitively accessing information applications that enhance the telephone network services.

10. The method of claim 7 wherein the telephone and the enhanced-feature device are integrated as a single device.

11. The method of claim 7 wherein the interface to the enhanced-feature device includes a display screen.
